(19) United States
(12) Patent Application Publication
(10) Pub. No.: US 2021/0197126 A1
(43) Pub. Date: Jul. 1, 2021

(54) HYDROGENATED NATURAL OILS TO THICKEN THE POLYOL COMPONENT OF A TWO-COMPONENT POLYURETHANE ADHESIVE FOR BONDING MEMBRANES

(71) Applicant: Henkel IP & Holding GmbH, Duesseldorf (DE)

(72) Inventors: Shuhua Jin, Cheshire, CT (US); Zachary Bryan, Middletown, CT (US); Chih-Min Cheng, Westford, MA (US); Li Kang, Middletown, CT (US); Aaron Fabas, West Hartford, CT (US); James Murray, Newmarket, NH (US)

(21) Appl. No.: 17/199,765

(22) Filed: Mar. 12, 2021

Related U.S. Application Data
(63) Continuation of application No. PCT/US2019/053704, filed on Sep. 28, 2019.
Application No. PCT/US2019/053704 is a continuation-in-part of application No. PCT/US2019/053702, filed on Sep. 28, 2019.
(60) Provisional application No. 62/738,088, filed on Sep. 28, 2018.
(60) Provisional application No. 62/738,079, filed on Sep. 28, 2018.

(51) Int. Cl. B01D 65/00; C09J 175/04; B01D 61/08; B01D 61/02; B01D 63/10

(52) U.S. Cl. CPC B01D 65/003; C09J 175/04; B01D 63/10; B01D 61/025; B01D 61/08

(57) ABSTRACT

Disclosed is a high-penetration two-component polyurethane adhesive for separation apparatus, such as thin film composite reverse osmosis filtration membranes. The polyisocyanate reactive side of the two-component adhesive comprises hydrogenated castor oil or derivative thereof to increase the viscosity and provide a thixotropic property. Surprisingly, these high-viscosity polyisocyanate reactive components provide a two-component polyurethane adhesive exhibiting excellent penetration of the membranes used in such separation apparatus. Also disclosed is a method of using these two component polyurethane adhesives to bond these membranes to one or more other components of a separation apparatus.

### FIELD OF THE INVENTION

This invention relates to two-component curable polyurethane systems that are used as the adhesive to bond together components of a separation apparatus such as membrane leaves used for reverse osmosis. The inventive compositions, when the two components are combined, result in polyurethane adhesives that are able to effectively penetrate the separation membrane. In one embodiment the invention is also directed to the membrane leaf that is bonded using this two-component curable polyurethane system. One component of such curable systems comprises an isocyanate functional pre-polymer that is the reaction product of a mixture comprising a polyisocyanate and polypropylene glycol. The pre-polymer comprises an average of at least two isocyanate functionalities per molecule. The other component of the two-component system is a composition comprising an isocyanate reactive component. The two components must be stored separately. These two components are mixed just before use and react together (“cure”) to form a polymer, generally in 1 to 8 hours after mixing. Typically, but not always, the isocyanate reactive component is a polyol or polyamine that is capable of reacting with the polyisocyanate pre-polymer, thereby forming a polyurethane (if a polyol is reacted) or polyurea (if a polyamine is reacted). In one preferred embodiment this invention relates to increasing the viscosity and shear-thinning of these two-component polyurethane adhesive compositions by blending castor oil based thixotropes into the isocyanate-reactive component.

### BACKGROUND OF THE INVENTION

Two-component curable polyurethane adhesive systems are a commonly used adhesive to bond reverse osmosis membranes that are used for filtration. There are performance requirements for these adhesives, such as good chemical resistance, good penetration to membranes, and no blister formation during filtration and washing of a filtration element that is constructed from these membranes. In general, high penetration of the membrane by the adhesive during construction leads to fewer blistering issues of the filtration element constructed from the membrane using the adhesive. Therefore, it is desirable to formulate a two-component curable polyurethane adhesive system with good penetration of these reverse osmosis membranes.

Mixed two-component curable polyurethane adhesive systems can be applied using a number of methods. Importantly, the adhesive must be applied in a narrow band or bead on or near the edge of the membrane during construction of the filtration element. Viscosity is therefore an important characteristic of these two-component adhesives. The two component adhesive, after mixing, needs to have a high enough viscosity to prevent sagging or excessive spreading of the bead of adhesive.

The viscosity of the newly mixed adhesive will be a composite of the viscosity of each component. Each application method will require the newly mixed adhesive to be within a different, defined viscosity range for successful use; below this range the applied mixture will unacceptably spread and run and above this range the mixed adhesive may not apply evenly or at all. Control of viscosity is therefore an important parameter for good penetration of reverse-osmosis membranes. A skilled worker can appreciate that there is also a delicate balance between high enough viscosity so that the bead of applied two-component curable adhesive applied to the membrane during construction of a reverse-osmosis filtration element does not sag or spread, and low enough viscosity for the adhesive to penetrate the membrane to achieve adequate bonding.

There are many organic and inorganic thickening agent/rheology modifiers used in two-component curable polyurethane adhesive systems. Typical inorganic thickening agents or rheology modifiers are organoclays, silicas such as silane modified fumed silicas. However, while these inorganic rheology modifiers can increase viscosity they also decrease membrane penetration. Furthermore, the high loading amount needed for these additives to increase viscosity also degrades adhesive performance.

### SUMMARY OF THE INVENTION

The inventors have unexpected discovered that relatively high levels of castor oil wax, when added to the isocyanate-reactive component of these two-component adhesive systems effectively increases the viscosity of the mixed adhesive, while simultaneously not having a deleterious effect on the membrane penetration of the mixed adhesive. A counter-intuitive result was seen in some cases, wherein higher viscosity adhesive compositions provided higher membrane penetration.

Castor oil wax, which is also referred to as hydrogenated castor oil, is a non-hazardous organic rheology modifier derived from castor oil which is a renewable resource. It gives very high thixotropy property. As is known in the art, thixotropy is a time-dependent shear-thinning property wherein the viscosity of a fluid is reduced at higher shear rates and then takes a period of time to recover to the original, high viscosity after the shear is removed. In this invention, hydrogenated castor oil or a derivative thereof is blended with the isocyanate reactive component which is one part of a two-component polyurethane adhesive system. Usually, but not always, the isocyanate reactive component is a polyol, such as (non-hydrogenated) castor oil. The addition of these hydrogenated castor oil waxes results in a highly thixotropic polyol, which when combined with the polyisocyanate component to form an adhesive, results in an adhesive capable of achieving surprisingly high penetration of membranes that are used for reverse osmosis.

In this invention, hydrogenated castor oil thixotropes are used as organic rheology modifiers of the isocyanate reactive component to achieve high viscosity and a thixotropic property. Hydrogenated castor oil thixotropes are non-hazardous organic rheology modifiers derived from the renewable resource castor oil. These materials are typically processed into easily dispersible powders, having a fine particle size, for example less than 44 microns. The thixotropic property is activated by first mixing the hydrogenated castor oil into the polyisocyanate reactive component using high shear while heating. The mixture is then cooled causing an activated network formation. Thus, these hydrogenated caster oils (or derivatives thereof) act as an effective rheology additive which builds up viscosity and a high degree of thixotropy in the polyisocyanate reactive component.

Also, surprisingly, the reactivity of the hydroxyl groups on the hydrogenated castor oil do not appear to degrade thixotropy of the isocyanate components or the resulting adhesive system.

In membrane filtration, there is a growing need for adhesives that can penetrate deeply into the materials of the membrane layers to help solve common problems such as blistering. “Blistering” is generally understood to mean a failure of the membrane near the bonded portion of the membrane, usually due to the incursion of water between the layers of a thin-film composite membrane. The disclosed two-component adhesive materials have the desirable ability to penetrate the membrane layer materials. Generally, improved penetration of the membrane (greater than 40%) by the adhesive is correlated with lower incidence of blistering. For consumers, less blistering means fewer failures of the membrane, which gives them greater reliability and value.

In one embodiment the invention is directed to the use of the disclosed two-component adhesive systems for bonding components of a separation apparatus together, such as membrane sheets of spiral-wound membrane filters used for reverse osmosis or nano filtration applications.

In one embodiment the invention is directed to a method of assembling a spiral wound filtration module. In this embodiment one or more membrane leaf elements, each of which contains a feed carrier, are wrapped about a central permeate collection tube. Each membrane leaf element includes two generally rectangular membrane sheets with a feed carrier sheet disposed between. The membrane leaf element is held together by the inventive adhesive along three edges of each membrane sheet and three edges of the feed carrier: the back edge farthest from the permeate tube, and the two side edges. Cured reaction products of the mixed adhesive make the bonded edges of the membrane leaf element impermeable to ingress of the feed material into the interior of the membrane leaf and escape of the filtered permeate out of the interior of the membrane leaf. In this way the permeate carrier within the sealed membrane leaf provides a fluid conduit to direct the filtered permeate to the perforated permeate collection tube. In some embodiments adhesive at the two side edges additionally affix and seal membrane leaf elements to the permeate collection tube.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

### BRIEF DESCRIPTION OF THE FIGURES

FIG. 1 shows a schematic cross section of a typical reverse-osmosis membrane;

FIG. 2 shows a schematic representation of a spiral-wound membrane element in use;

FIG. 3 shows a step in the construction of a membrane leaf element; and

FIG. 4 shows another step in the construction of a membrane leaf element as part of a spiral-wound membrane element.

FIG. 5 is a schematic cross sectional representation of a portion of a membrane leaf element.

### DETAILED DESCRIPTION OF THE INVENTION

Unless defined otherwise, all technical and scientific terms used herein have the same meaning as is commonly understood by one of ordinary skill in the art. As used herein for each of the various embodiments, the following definitions apply.

“Alkyl” or “alkane” refers to a hydrocarbon chain or group containing only single bonds between the chain carbon atoms. The alkane can be a straight hydrocarbon chain or a branched hydrocarbon group. The alkane can be cyclic. The alkane can contain 1 to 20 carbon atoms, advantageously 1 to 10 carbon atoms and more advantageously 1 to 6 carbon atoms. In some embodiments the alkane can be substituted. Exemplary alkanes include methyl, ethyl, n-propyl, isopropyl, isobutyl, n-butyl, sec-butyl, tert-butyl, isopentyl, neopentyl, tert-pentyl, isohexyl and decyl.

“Alkenyl” or “alkene” refers to a hydrocarbon chain or group containing one or more double bonds between the chain carbon atoms. The alkenyl can be a straight hydrocarbon chain or a branched hydrocarbon group. The alkene can be cyclic. The alkene can contain 1 to 20 carbon atoms, advantageously 1 to 10 carbon atoms and more advantageously 1 to 6 carbon atoms. The alkene can be an allyl group. The alkene can contain one or more double bonds that are conjugated. In some embodiments the alkene can be substituted.

“Alkoxy” refers to the structure —OR, wherein R is hydrocarbyl.

“Alkyne” or “alkynyl” refers to a hydrocarbon chain or group containing one or more triple bonds between the chain carbon atoms. The alkyne can be a straight hydrocarbon chain or a branched hydrocarbon group. The alkyne can be cyclic. The alkyne can contain 1 to 20 carbon atoms, advantageously 1 to 10 carbon atoms and more advantageously 1 to 6 carbon atoms. The alkyne can contain one or more triple bonds that are conjugated. In some embodiments the alkyne can be substituted.

“Amine” refers to a molecule comprising at least one —NHR group wherein R can be a covalent bond, H, hydrocarbyl or polyether. In some embodiments an amine can comprise a plurality of —NHR groups (which may be referred to as a polyamine).

“Aryl” or “Ar” refers to a monocyclic or multicyclic aromatic group. The cyclic rings can be linked by a bond or fused. The aryl can contain from 6 to about 30 carbon atoms; advantageously 6 to 12 carbon atoms and in some embodiments 6 carbon atoms. Exemplary aryls include phenyl, biphenyl and naphthyl. In some embodiments the aryl is substituted.

“Ester” refers to the structure R—C(O)—O—R′ where R and R′ are independently selected hydrocarbyl groups with or without heteroatoms. The hydrocarbyl groups can be substituted or unsubstituted.

“Halogen” or “halide” refers to an atom selected from fluorine, chlorine, bromine and iodine.

“Hetero” refers to one or more heteroatoms in a structure. Exemplary heteroatoms are independently selected from N, O and S.

“Heteroaryl” refers to a monocyclic or multicyclic aromatic ring system wherein one or more ring atoms in the structure are heteroatoms. Exemplary heteroatoms are independently selected from N, O and S. The cyclic rings can be linked by a bond or fused. The heteroaryl can contain from 5 to about 30 carbon atoms; advantageously 5 to 12 carbon atoms and in some embodiments 5 to 6 carbon atoms. Exemplary heteroaryls include furyl, imidazolyl, pyrimidinyl, tetrazolyl, thienyl, pyridyl, pyrrolyl, thiazolyl, isothiazolyl, oxazolyl, isoxazolyl, thiazolyl, quinolinyl and isoquinolinyl. In some embodiments the heteroaryl is substituted.

“Hydrocarbyl” refers to a group containing carbon and hydrogen atoms. The hydrocarbyl can be linear, branched, or cyclic group. The hydrocarbyl can be alkyl, alkenyl, alkynyl or aryl. In some embodiments, the hydrocarbyl is substituted.

“(Meth)acrylate” refers to acrylate and methacrylate.

“Molecular weight” refers to weight average molecular weight unless otherwise specified. The number average molecular weight Mn, as well as the weight average molecular weight M_{w}, is determined according to the present invention by gel permeation chromatography (GPC, also known as SEC) at 23° C. using a styrene standard. This method is known to one skilled in the art. The polydispersity is derived from the average molecular weights M_{w} and Mₙ. It is calculated as PD=M_{w}/Mₙ. Polydispersity indicates the width of the molecular weight distribution and thus of the different degrees of polymerization of the individual chains in polydisperse polymers. For many polymers and polycondensates, a polydispersity value of about 2 applies. Strict monodispersity would exist at a value of 1. A low polydispersity of, for example, less than 1.5 indicates a comparatively narrow molecular weight distribution.

“Oligomer” refers to a defined, small number of repeating monomer units such as 2-5,000 units, and advantageously 10-1,000 units which have been polymerized to form a molecule. Oligomers are a subset of the term polymer.

“Polyether” refers to polymers which contain multiple ether groups (each ether group comprising an oxygen atom connected top two hydrocarbyl groups) in the main polymer chain. The repeating unit in the polyether chain can be the same or different. Exemplary polyethers include homopolymers such as polyoxymethylene, polyethylene oxide, polypropylene oxide, polybutylene oxide, polytetrahydrofuran, and copolymers such as poly(ethylene oxide co propylene oxide), and EO tipped polypropylene oxide.

“Polyester” refers to polymers which contain multiple ester linkages. A polyester can be either linear or branched.

“Polymer” refers to any polymerized product greater in chain length and molecular weight than the oligomer. Polymers can have a degree of polymerization of about 20 to about 25000. As used herein polymer includes oligomers and polymers.

“Polyol” refers to a molecule comprising two or more —OH groups.

“Substituted” refers to the presence of one or more substituents on a molecule in any possible position. Useful substituents are those groups that do not significantly diminish the disclosed reaction schemes. Exemplary substituents include, for example, H, halogen, (meth)acrylate, epoxy, oxetane, urea, urethane, N₃, NCS, CN, NCO, NO₂, NX¹X², OX¹, C(X¹)₃, C(halogen)₃, COOX¹, SX¹, Si(OX¹)iX²₃₋ᵢ, alkyl, alcohol, alkoxy; wherein X¹ and X² each independently comprise H, alkyl, alkenyl, alkynyl or aryl and i is an integer from 0 to 3.

“Thiol” refers to a molecule comprising at least one —SH group. In some embodiments a thiol can comprise a plurality of —SH groups (which may be referred to as a polythiol).

This invention relates to two-component or two-part curable polymeric systems.

The first component of such systems comprises a polyisocyanate component. The second component of the two-part curable polymeric system is a material that is capable of reacting with the polyisocyanate material to form a polymeric material. This component is referred to herein as “the isocyanate reactive component”.

### Polyisocyanate Component

The polyisocyanate component can be any compound having on average two or more isocyanate groups. As incorporated herein the term “polyisocyanate” encompasses diisocyanate, polymeric isocyanates, and isocyanate-terminated oligomers and polymers. One or more of the polyisocyanates described below can individually be used in, or excluded from, the polyisocyanate component.

Some advantageous polyisocyanate components have the general structure O═C═N—X—N═C═O where X is an aliphatic, alicyclic or aryl radical, preferably an aliphatic or alicyclic radical containing 4 to 18 carbon atoms.

Some suitable isocyanates include 1,5-naphthylene diisocyanate, diphenyl methane diisocyanate (MDI) including the 2,2′-2,4′- and 4,4′-isomers, polymeric MDI (pMDI), hydrogenated MDI (HMDI), xylylene diisocyanate (XDI), tetramethyl xylylene diisocyanate (TMXDI), di- and tetraalkylene diphenylmethane diisocyanate, 4,4′-dibenzyl diisocyanate, 1,3-phenylene diisocyanate, 1,4-phenylene diisocyanate, the isomers of toluene diisocyanate (TDI), 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether4,4′-diphenyl diisocyanate. Aromatic polyisocyanates are preferred and diphenyl methane diisocyanate (MDI) and its isomers and polymeric MDI (pMDI) are more preferred as part or all of the polyisocyanates used for synthesis of the pre-polymers.

Some suitable isocyanates include isocyanate functional pre-polymers. Such pre-polymers are formed by reacting excess amount of polyisocyanate with a polyol, a polyamine, polythiol, or the combination of them. “Excess” is understood to mean that there are more equivalents of isocyanate functionality from the polyisocyanate compound than equivalents of hydroxyl functionality from the polyol present during reaction to form the pre-polymer. In this disclosure, it is to be understood that the terms polyisocyanate pre-polymer or pre-polymer or isocyanate functional pre-polymer are applied to any compound made according to the forgoing description, i.e., as long as the compound is made with at least a stoichiometric excess of isocyanate groups to isocyanate reactive groups it will be referred to herein as polyisocyanate pre-polymer or a pre-polymer or isocyanate functional pre-polymer.

Sulfur-containing polyisocyanates are obtained, for example, by reaction of 2 mole hexamethylene diisocyanate with 1 mole thiodiglycol or dihydroxydihexyl sulfide. Other suitable diisocyanates are, for example, trimethyl hexamethylene diisocyanate, 1,4-diisocyanatobutane, 1,12-diisocyanatododecane and dimer fatty acid diisocyanate. Suitable diisocyanates are the tetramethylene diisocyanate, hexamethylene diisocyanate, undecane diisocyanate, dodecamethylene diisocyanate, 2,2,4-trimethylhexane-2,3,3-trimethylhexamethylene diisocyanate, 1,3-cyclohexane diisocyanate, 1,4-cyclohexane diisocyanate, 1,3- and 1,4-tetramethyl xylene diisocyanate, isophorone, 4,4-dicyclohexylmethane, tetramethylxylylene (TMXDI) and lysine ester diisocyanate.

Aliphatic polyisocyanates with two or more isocyanate functionality formed by biuret linkage, uretdione linkage, allophanate linkage, and/or by trimerization are suitable.

Suitable at least trifunctional isocyanates are polyisocyanates formed by trimerization or oligomerization of diisocyanates or by reaction of diisocyanates with polyfunctional compounds containing hydroxyl or amino groups. Isocyanates suitable for the production of trimers are the diisocyanates mentioned above, the trimerization products of HDI, MDI, TDI or IPDI being preferred.

Blocked, reversibly capped polyisocyanates, such as 1,3,5-tris-[6-(1-methylpropylideneaminoxycarbonylamino)-hexyl]-2,4,6-trix-ohexahydro-1,3,5-triazine, are also suitable.

The polymeric isocyanates formed, for example, as residue in the distillation of diisocyanates are also suitable for use.

The polyisocyanate component encompasses a single polyisocyanate or the mixture of two or more polyisocyanates.

### Isocyanate Reactive Component

The isocyanate reactive component of the present invention comprises one or more isocyanate reactive compounds. As used herein an isocyanate reactive compound is a compound containing one or more, preferably two or more, functional moieties that will react with an isocyanate moiety. The isocyanate reactive component can be a single compound comprising one or more of an alcohol moiety, an amine moiety, a thiol moiety, or a compound with a plurality of one type of moiety or a combination of different moieties. The isocyanate reactive component can be a mixture of compounds with each compound comprising one or more moieties independently selected from alcohol, amine, thiol and aminoalcohol. One or more of the polyols, amines, thiols and aminoalcohols described below can individually be used or excluded from the isocyanate reactive component as desired.

In one embodiment the isocyanate reactive component can comprise a polyol. A polyol is understood to be a compound containing more than one OH group in the molecule. A polyol can further have other functionalities on the molecule. The term “polyol” encompasses a single polyol or a mixture of two or more polyols.

Some suitable polyol components include aliphatic alcohols containing 2 to 8 OH groups per molecule. The OH groups may be both primary and secondary. Some suitable aliphatic alcohols include, for example, ethylene glycol, propylene glycol, butane-1,4-diol, pentane-1,5-diol, hexane-1,6-diol, heptane-1,7-diol, octane-1,8-diol and higher homologs or isomers thereof which the expert can obtain by extending the hydrocarbon chain by one CH₂ group at a time or by introducing branches into the carbon chain. Also suitable are higher alcohols such as, for example, glycerol, trimethylol propane, pentaerythritol and oligomeric ethers of the substances mentioned either individually or in the form of mixtures of two or more of the ethers mentioned with one another.

Some suitable polyols include the reaction products of low molecular weight polyhydric alcohols with alkylene oxides, so-called polyether polyols. The alkylene oxides preferably contain 2 to 4 carbon atoms. Some reaction products of this type include, for example, the reaction products of ethylene glycol, propylene glycol, the isomeric butane diols, hexane diols or 4,4′-dihydroxydiphenyl propane with ethylene oxide, propylene oxide or butylene oxide or mixtures of two or more thereof. The reaction products of polyhydric alcohols, such as glycerol, trimethylol ethane or trimethylol propane, pentaerythritol or sugar alcohols or mixtures of two or more thereof, with the alkylene oxides mentioned to form polyether polyols are also suitable. Thus, depending on the desired molecular weight, products of the addition of only a few mol ethylene oxide and/or propylene oxide per mol or of more than one hundred mol ethylene oxide and/or propylene oxide onto low molecular weight polyhydric alcohols may be used. Other polyether polyols are obtainable by condensation of, for example, glycerol or pentaerythritol with elimination of water. Some suitable polyols include those polyols obtainable by polymerization of tetrahydrofuran.

The polyethers are reacted in known manner by reacting the starting compound containing a reactive hydrogen atom with alkylene oxides, for example ethylene oxide, propylene oxide, butylene oxide, styrene oxide, tetrahydrofuran or epichlorohydrin or mixtures of two or more thereof.

Suitable starting compounds are, for example, water, ethylene glycol, 1,2-or 1,3-propylene glycol, 1,4- or 1,3-butylene glycol, hexane-1,6-diol, octane-1,8-diol, neopentyl glycol, 1,4-hydroxymethyl cyclohexane, 2-methyl propane-1,3-diol, glycerol, trimethylol propane, hexane-1,2,6-triol, butane-1,2,4-triol, trimethylol ethane, pentaerythritol, mannitol, sorbitol, methyl glycosides, sugars, phenol, isononylphenol, resorcinol, hydroquinone, 1,2,2- or 1,1,2-tris-(hydroxyphenyl)-ethane, ammonia, methyl amine, ethylenediamine, tetra- or hexamethylenediamine, triethanolamine, aniline, phenylenediamine, 2,4- and 2,6-diam inotoluene and polyphenylpolymethylene polyamines, which may be obtained by aniline/formaldehyde condensation, or mixtures of two or more thereof.

Some suitable polyols include diol EO/PO (ethylene oxide/propylene oxide) block copolymers, EO-tipped polypropylene glycols, or alkoxylated bisphenol A.

Some suitable polyols include polyether polyols modified by vinyl polymers. These polyols can be obtained, for example, by polymerizing styrene or acrylonitrile or mixtures thereof in the presence of polyether polyol.

Some suitable polyols include polyester polyols. For example, it is possible to use polyester polyols obtained by reacting low molecular weight alcohols, more particularly ethylene glycol, diethylene glycol, neopentyl glycol, hexanediol, butanediol, propylene glycol, glycerol or trimethylol propane, with caprolactone. Other suitable polyhydric alcohols for the production of polyester polyols are 1,4-hydroxymethyl cyclohexane, 2-methyl propane-1,3-diol, butane-1,2,4-triol, triethylene glycol, tetraethylene glycol, polyethylene glycol, dipropylene glycol, polypropylene glycol, dibutylene glycol and polybutylene glycol.

Some suitable polyols include polyester polyols obtained by polycondensation. Thus, dihydric and/or trihydric alcohols may be condensed with less than the equivalent quantity of dicarboxylic acids and/or tricarboxylic acids or reactive derivatives thereof to form polyester polyols. Suitable dicarboxylic acids are, for example, adipic acid or succinic acid and higher homologs thereof containing up to 16 carbon atoms, unsaturated dicarboxylic acids, such as maleic acid or fumaric acid, cyclohexane dicarboxylic acid (CHDA), and aromatic dicarboxylic acids, more particularly the isomeric phthalic acids, such as phthalic acid, isophthalic acid or terephthalic acid. Citric acid and trimellitic acid, for example, are also suitable tricarboxylic acids. The acids mentioned may be used individually or as mixtures of two or more thereof. Polyester polyols of at least one of the dicarboxylic acids mentioned and glycerol which have a residual content of OH groups are suitable. Suitable alcohols include but are not limited to propylene glycol, butane diol, pentane diol, hexanediol, ethylene glycol, diethylene glycol, triethylene glycol, dipropylene glycol, tripropylene glycol, cyclohexanedimethanol (CHDM), 2-methyl-1,3-propanediol (MPDiol), or neopentyl glycol or isomers or derivatives or mixtures of two or more thereof. High molecular weight polyester polyols may be used in the second synthesis stage and include, for example, the reaction products of polyhydric, preferably dihydric, alcohols (optionally together with small quantities of trihydric alcohols) and polybasic, preferably dibasic, carboxylic acids. Instead of free polycarboxylic acids, the corresponding polycarboxylic anhydrides or corresponding polycarboxylic acid esters with alcohols preferably containing 1 to 3 carbon atoms may also be used (where possible). The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are, for example, succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof. Small quantities of monofunctional fatty acids may optionally be present in the reaction mixture.

The polyester polyol may optionally contain a small number of terminal carboxyl groups. Polyesters obtainable from lactones, for example based on ε-caprolactone (also known as “polycaprolactones”), or hydroxycarboxylic acids, for example ω-hydroxycaproic acid, may also be used.

Polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group.

Some suitable polyols include C36 dimer diols and derivatives thereof. Some suitable polyols include castor oil and derivatives thereof. Some suitable polyols include fatty polyols, for example the products of hydroxylation of unsaturated or polyunsaturated natural oils, the products of hydrogenations of unsaturated and polyunsaturated polyhydroxy natural oils, polyhydroxyl esters of alkyl hydroxyl fatty acids, polymerized natural oils, soybean polyols, and alkylhydroxylated amides of fatty acids. Some suitable polyols include the hydroxy functional polybutadienes known, for example, by the commercial name of “Poly-BD®” available from Cray Valley USA, LLC Exton, Pa. Some suitable polyols include polyisobutylene polyols. Some suitable polyols include polyacetal polyols. Polyacetal polyols are understood to be compounds obtainable by reacting glycols, for example diethylene glycol or hexanediol or mixtures thereof, with formaldehyde. Polyacetal polyols may also be obtained by polymerizing cyclic acetals. Some suitable polyols include polycarbonate polyols. Polycarbonate polyols may be obtained, for example, by reacting diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate, or phosgene. Some suitable polyols include polyamide polyols.

Some suitable polyols include polyacrylates containing OH groups. These polyacrylates may be obtained, for example, by polymerizing ethylenically unsaturated monomers bearing an OH group. Such monomers are obtainable, for example, by esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

The isocyanate reactive component can comprise or be a compound comprising an amine moiety. The amine moieties can be primary amine moieties, secondary amine moieties, or combinations of both. In some embodiments the compound comprises two or more amine moieties independently selected from primary amine moieties and secondary amine moieties (polyamine). In some embodiments the compound can be represented by a structure selected from HRN-Z and HRN-Z-NRH where Z is a hydrocarbyl group having 1 to 20 carbon atoms and R can be a covalent bond, H, hydrocarbyl, heterohydrocarbyl or polyether. In some embodiments Z is a straight or branched alkane or a straight or branched polyether. In some embodiments Z can be a heterohydrocarbyl group. In some embodiments Z can be a polymeric and/or oligomeric backbone. Such polymeric/oligomeric backbone can contain ether, ester, urethane, acrylate linkages. In some embodiments R is H. The term polyamine refers to a compound contains more than one —NHR group where R can be a covalent bond, H, hydrocarbyl, heterohydrocarbyl.

Some suitable amine compounds include but are not limited to aliphatic polyamines, arylaliphatic polyamines, cycloaliphatic polyamines, aromatic polyamines, heterocyclic polyamines, polyalkoxypolyamines, and combinations thereof. The alkoxy group of the polyalkoxypolyamines is an oxyethylene, oxypropylene, oxy-I,2-butylene, oxy-I,4-butylene or a co-polymer thereof.

Examples of aliphatic polyamines include, but are not limited to ethylenediamine (EDA), diethylenetriamine (DETA), triethylenetetramine (TETA), trimethyl hexane diamine (TMDA), hexamethylenediamine (NMDA), N-(2-aminoethyl)-I,3-propanediamine (N3-Amine), N,N′-I,2-ethanediylbis-I,3-propanediamine (N4-amine), and dipropylenetriamine. Examples of arylaliphatic polyamines include, but are not limited to m-xylylenediamine (mXDA), and p-xylylenediamine. Examples of cycloaliphatic polyamines include, but are not limited to 1,3-bisaminocyclohexylamine (1,3-BAC), isophorone diamine (IPDA), and 4,4′-methylenebiscyclohexanamine. Examples of aromatic polyamines include, but are not limited to diethyltoluenediamine (DETDA), m-phenylenediamine, diaminodiphenylmethane (DDM), and diaminodiphenylsulfone (DDS). Examples of heterocyclic polyamines include, but are not limited to N-aminoethylpiperazine (NAEP), and 3,9-bis(3-aminopropyl) 2,4,8,10-tetraoxaspiro(5,5)undecane. Examples of polyalkoxypolyamines where the alkoxy group is an oxyethylene, oxypropylene, oxy-1,2-butylene, oxy-I,4-butylene or a co-polymer thereof include, but are not limited to 4,7-dioxadecane-I,10-diamine, 1-propanamine,2, I-ethanediyloxy))bis(diaminopropylated diethylene glycol). Suitable commercially available polyetheramines include those sold by Huntsman under the Jeffamine® trade name. Suitable polyether diamines include Jeffamines® in the D, SD, ED, XTJ, and DR series. Suitable polyether triamines include Jeffamines® in the T and ST series.

Suitable commercially available polyamines also include aspartic ester-based amine-functional resins (Bayer); dimer diamines e.g. Priamine® (Croda); or diamines such as Versalink® (Evonik).

The amine compound may include other functionalities in the molecule. The amine compound encompasses a single compound or a mixture of two or more amine compounds.

The isocyanate reactive component can comprise or be a thiol. In some embodiments the thiol comprises two or more —SH moieties (polythiol). In some embodiments the thiol comprises at least one —SH moiety and at least another functional moiety selected from —OH, —NH, —NH₂, —COON, or epoxide. In some embodiments the thiol can be represented by the structure HS—Z—SH where Z is a hydrocarbyl group, a heterohydrocarbyl group having 1 to 50 carbon atoms. In some embodiments Z is a straight or branched alkane or a straight or branched polyether. Some suitable thiols include but are not limited to pentaerythritol tetra-(3-mercaptopropionate) (PETMP), pentaerythritol tetrakis(3-mercaptobutylate) (PETMB), trimethylolpropane tri-(3-mercaptopropionate) (TMPMP), glycol di-(3-mercaptopropionate) (GDMP), pentaerythritol tetramercaptoacetate (PETMA), trimethylolpropane trimercaptoacetate (TMPMA), glycol dimercaptoacetate (GDMA), ethoxylated trimethylpropane tri(3-mercapto-propionate) 700 (ETTMP 700), ethoxylated trimethylpropane tri(3-mercapto-propionate) 1300 (ETTMP 1300), propylene glycol 3-mercaptopropionate 800 (PPGMP 800), propylene glycol 3-mercaptopropionate 2200 (PPGMP 2200), pentaerythritol tetrakis(3-mercaptobutanoate) (KarenzMT PE-1 from Showa Denko), and soy polythiols (Mercaptanized Soybean Oil). The term “thiol” encompasses a single thiol or a mixture of two or more thiols.

The isocyanate reactive component can comprise or be a compound comprising an aminoalcohol moiety. As used herein an aminoalcohol moiety comprises at least one amino moiety and at least one hydroxyl moiety. In some embodiments the amine group is terminal to the aminoalcohol compound molecule. In some embodiments the amine group is a secondary amino group on the chain of the aminoalcohol compound molecule. In some embodiments the aminoalcohol compound includes a terminal primary amine and a secondary amine. In some embodiments the aminoalcohol compound can be represented by one of the following structures: HO—Z—NH-Z—OH or H₂N—Z—NH—Z—OH or H₂N—Z—(OH)₂ where Z is a hydrocarbyl group and/or an heterohydrocarbyl having 1 to 50 carbon atoms. In some embodiments Z is a straight or branched alkane or a straight or branched polyether. In some embodiments Z contains cycloaliphatic moiety or aryl moiety. Some suitable aminoalcohols include but are not limited to diethanolamine, dipropanolamine, 3-amino-1,2-propanediol, 2-amino-1,3-propane diol, 2-amiono-2-methyl-1,3-propanediol, diisopropanolamine. The aminoalcohol compound encompasses a single compound or a mixture of two or more aminoalcohol compounds.

### Additives:

The two-component polyurethane adhesives can optionally include, or exclude, one or more additives. The additives can be contained in either or both of the polyisocyanate component or the polyisocyanate-reactive component (e.g., polyol or polyamine) as long as they will not deleteriously react with that component.

The curable compositions (two component polyurethane adhesives) disclosed herein can include a catalyst or cure-inducing component to modify speed of the initiated reaction. Some suitable catalysts are those conventionally used in polyurethane reactions and polyurethane curing, including organometallic catalysts, organotin catalysts and amine catalysts. Exemplary catalysts include (1,4-diazabicyclo[2.2.2]octane) DABCO® T-12 or DABCO® crystalline, available from Evonik; DMDEE (2,2′-dimorpholinildiethylether); DBU (1,8-diazabicyclo[5.4.0]undec-7-ene). The curable composition can optionally include from about 0.01% to about 10% by weight of composition of one or more catalysts or cure-inducing components. Preferably, the curable composition can optionally include from about 0.05% to about 3% by weight of composition of one or more catalysts or cure-inducing components.

The curable composition can optionally include filler. Some useful fillers include, for example, lithopone, zirconium silicate, hydroxides, such as hydroxides of calcium, aluminum, magnesium, iron and the like, diatomaceous earth, carbonates, such as sodium, potassium, calcium, and magnesium carbonates, oxides, such as zinc, magnesium, chromic, cerium, zirconium and aluminum oxides, calcium clay, nanosilica, fumed silicas, silicas that have been surface treated with a silane or silazane such as the AEROSIL® products available from Evonik Industries, silicas that have been surface treated with an acrylate or methacrylate such as AEROSIL® R7200 or R711 available from Evonik Industries, precipitated silicas, untreated silicas, graphite, synthetic fibers and mixtures thereof. When used, filler can be employed in concentrations effective to provide desired properties in the uncured composition and cured reaction products and typically in concentrations of about 0% to about 90% by weight of composition, more typically 1% to 30% by weight of composition of filler. Suitable fillers include organoclays such as, for example, Cloisite® nanoclay sold by Southern Clay Products and exfoliated graphite such as, for example, xGnP® graphene nanoplatelets sold by XG Sciences. In some embodiments, enhanced barrier properties are achieved with suitable fillers.

The curable composition can optionally include a thixotrope or rheology modifier in addition to the hydrogenated castor oil or derivatives thereof disclosed herein that is to be included in the polyisocyanate reactive component of the two-component adhesive system.

The additional thixotropic agent can modify rheological properties of the uncured composition. Some useful thixotropic agents include, for example, silicas, such as fused or fumed silicas, that may be untreated or treated so as to alter the chemical nature of their surface. Virtually any reinforcing fused, precipitated silica, fumed silica or surface treated silica may be used. Examples of treated fumed silicas include polydimethylsiloxane-treated silicas, hexamethyldisilazane-treated silicas and other silazane or silane treated silicas. Such treated silicas are commercially available, such as from Cabot Corporation under the tradename CAB-O-SIL® ND-TS and Evonik Industries under the tradename AEROSIL®, such as AEROSIL® R805. Also useful are the silicas that have been surface treated with an acrylate or methacrylate such as AEROSIL® R7200 or R711 available from Evonik Industries. Examples of untreated silicas include commercially available amorphous silicas such as AEROSIL® 300, AEROSIL® 200 and AEROSIL® 130. Commercially available hydrous silicas include NIPSIL® E150 and NIPSIL® E200A manufactured by Japan Silica Kogya Inc.

The rheology modifier can be employed in concentrations effective to provide desired physical properties in the uncured composition and cured reaction products and typically in concentrations of about 0% to about 70% by weight of the composition and advantageously in concentrations of about 0% to about 20% by weight of the composition. In certain embodiments the filler and the rheology modifier can be the same.

The curable composition can optionally include an antioxidant. Some useful antioxidants include those available commercially from BASF under the tradename IRGANOX®. When used, the antioxidant should be present in the range of about 0 to about 15 weight percent of curable composition, such as about 0.3 to about 1 weight percent of curable composition.

The curable composition can optionally include a reaction modifier. A reaction modifier is a material that will increase or decrease reaction rate of the curable composition. For example, 8-hydroxyquinoline (8-HQ) and derivatives thereof such as 5-hydroxymethyl-8-hydroxyquinoline can be used to adjust the cure speed. When used, the reaction modifier can be used in the range of about 0.001 to about 15 weight percent of curable composition.

The curable composition can optionally contain a thermoplastic polymer. The thermoplastic polymer may be either a functional or a non-functional thermoplastic. Non-limiting examples of suitable thermoplastic polymers include acrylic polymer, functional (e.g. containing reactive moieties such as —OH and/or —COON) acrylic polymer, non-functional acrylic polymer, acrylic block copolymer, acrylic polymer having tertiary-alkyl amide functionality, polysiloxane polymer, polystyrene copolymer, divinylbenzene copolymer, polyetheramide, polyvinyl acetal, polyvinyl butyral, polyvinyl chloride, methylene polyvinyl ether, cellulose acetate, styrene acrylonitrile, amorphous polyolefin, olefin block copolymer [OBC], polyolefin plastomer, thermoplastic urethane, polyacrylonitrile, ethylene acrylate copolymer, ethylene acrylate terpolymer, ethylene butadiene copolymer and/or block copolymer, styrene butadiene block copolymer, and mixtures of any of the above. The amount of thermoplastic polymer is not critical as long is the amount does not deleteriously affect the desired mixed adhesive viscosity and membrane penetration.

The curable composition can optionally include one or more adhesion promoters that are compatible and known in the art. Examples of useful commercially available adhesion promoters include amino silane, glycidyl silane, mercapto silane, isocyanato silane, vinyl silane, (meth)acrylate silane, and alkyl silane. Common adhesion promoters are available from Momentive under the trade name Silquest or from Wacker Chemie under the trade name Geniosil. Silane terminated oligomers and polymers can also be used. The adhesion promoter can be used in the range of about 0% to about 20% percent by weight of curable composition and advantageously in the range of about 0.1% to about 15% percent by weight of curable composition.

The curable composition can optionally include one or more coloring agents. For some applications a colored composition can be beneficial to allow for inspection of the applied composition. A coloring agent, for example a pigment or dye, can be used to provide a desired color beneficial to the intended application. Exemplary coloring agents include titanium dioxide, C.I. Pigment Blue 28, C.I. Pigment Yellow 53 and phthalocyanine blue BN. In some applications a fluorescent dye can be added to allow inspection of the applied composition under UV radiation. The coloring agent will be present in amounts sufficient to allow observation or detection, for example about 0.002% or more by weight of total composition. The maximum amount is governed by considerations of cost, absorption of radiation and interference with cure of the composition. More desirably, the coloring agent may be present in amounts of up to about 20% by weight of total composition.

The curable composition can optionally include from about 0% to about 20% by weight, for example about 1% to about 20% by weight of composition of other additives known in the arts, such as tackifier, plasticizer, flame retardant, diluent, reactive diluent, moisture scavenger, and combinations of any of the above, to produce desired functional characteristics, providing they do not significantly interfere with the desired properties of the curable composition or cured reaction products of the curable composition.

When used as an adhesive, the curable compositions can optionally include up to 80% by weight of the total weight of the curable composition of a suitable solvent.

### Castor Oil Based Rheology Modifiers

In this invention, castor oil thixotropes are present as rheology modifiers of the polyisocyanate reactive component of the polyurethane two-component adhesive to achieve high thixotropy properties in the polyisocyanate reactive component. Castor oil thixotropes are non-hazardous organic rheology modifiers derived from the renewable resource castor oil. They may be processed into fine particle size, easily dispersible powders. When mixed into the polyisocyanate reactive component, these castor oil thixotropes can be fully activated by heating. Then the mixture is cooled to effect an activated network, which increases the viscosity and effects a high degree of thixotropy. Particularly preferred are as castor oil thixotropes are hydrogenated castor oils or castor oil wax. The triglyceride of 12-hydroxystearic acid is the main component of hydrogenated castor oil.

The castor oil based rheology modifiers used in the practice of this invention comprise hydrogenated castor oil wax (sometimes referred to as “trihydroxystearin”) and derivatives thereof.

Examples of commercially available hydrogenated castor oil waxes include but are not limited to: EFKA® RM 1900 and EFKA® RM 1920 from (BASF); RHEOCIN® (BYK); and THIXICIN® R (Elementis).

Also suitable are organically modified hydrogenated castor oil derivatives and mixtures thereof with unmodified hydrogenated castor oil. Some non-limiting examples of organically modified hydrogenated castor oil derivatives or mixtures are: ADVITROL® 100 and (BYK); THIXATROL® GST (Elementis). Particularly suitable derivatives of hydrogenated castor oils are esters and amides of hydrogenated castor oil fatty acids (e.g., esters and amides of 12-hydroxystearic acid), and mixtures thereof, either with or without unmodified hydrogenated castor oil. A non-limiting example of such an amide is ethylenebis-12-hydroxystearamide.

Inorganically modified hydrogenated castor oil is also suitable in the practice of this invention. Examples of commercially available inorganically modified hydrogenated castor oil that can be used in the practice of this invention include but are not limited to: THIXCIN® GR (Elementis) and ADVITROL® 50 (BYK).

“Hydrogenated” in reference to castor oil or castor oil derivatives is understood to mean that the castor oil has been hydrogenated to remove or reduce the unsaturation in the fatty acid part of the molecule, but the hydroxyl groups remain. In some embodiments a typical, non-limiting, hydroxyl value for hydrogenated castor oil is 158, as measured by the number of milligrams of potassium hydroxide required to neutralize the acetic acid taken up on acetylation of one gram of a chemical substance that contains free hydroxyl groups. It is to be understood therefore that the hydrogenated castor oil is capable of reacting with the free NCO groups in the polyisocyanate that comprises one component of these two-component polyurethane adhesive systems. Typically, hydrogenated castor oil has an iodine value of less than 10 g I₂/100 g.

Suitable amounts of the hydrogenated castor oil or derivatives thereof are between 3 weight percent and 12 weight percent, for example between 5 weight percent and 8 weight percent, or of the isocyanate reactive component.

In an embodiment, the molar ratio of isocyanate groups of the polyisocyanate component to the isocyanate reactive functional groups of the isocyanate reactive component in the two-component adhesive should be in the range of 0.95:1.0 to 1.5:1.0. In an embodiment, the molar ratio of isocyanate groups of the polyisocyanate component to the isocyanate reactive functional groups of the isocyanate reactive component in the two-component adhesive is at least 1:1 to 1.5:1.0.

### Thixo Ratio:

The thixo ratio of a fluid is defined as the fluid viscosity at 1 sec⁻¹ divided by the fluid viscosity at 10 sec−1. The thixo ratio may also be the defined as the fluid viscosity at 2 sec⁻¹ divided by the fluid viscosity at 20 sec⁻¹. A shear thinning fluid will therefore have a thixo ratio that is greater than 1, for either of these definitions. A mixed two-component adhesive system is desirably shear thinning so that the two components can be easily mixed together and dispensed as a thin bead, but then the bead of adhesive will resist sagging and spreading. This is especially important for construction of spiral-wound membrane elements.

Membranes and use of the two-component adhesive system made with the isocyanate reactive component comprising hydrogenated castor oil or derivative thereof in spiral-wound membrane elements:

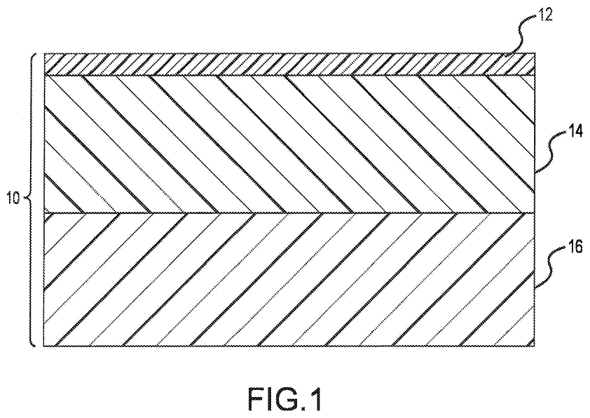

The following description refers to FIGS. 1-5.

A typical thin-film composite membrane 10 intended for reverse osmosis and/or nanofiltration is generally rectangular in shape and is comprised of overlying layers having the general structure shown as a schematic cross-section in FIG. 1. The membrane 10 comprises generally three layers: a thin, dense semi-permeable barrier layer 12 overlying a microporous substrate 14, the microporous substrate 14 overlying a porous support layer 16. The porous support layer 16 is for example, a non-woven polyester, but is not necessarily limited to a non-woven polyester. The porous support layer 16 is generally constructed and arranged to allow fluid to pass through it easily, while providing physical support for the other layers of the composite membrane 10. Likewise, the semi-permeable barrier layer 12 is commonly, but not necessarily a polyamide film, and the microporous substrate 14 is usually but not always comprised of a polysulfone film. The materials of construction and their thickness, etc. may be varied depending on the exact separation application for which the membrane 10 is intended to be used.

The semi-permeable layer 12 is the active surface of the membrane 10 and is usually considered to be effecting the separation, either on its own or in combination with the intermediate microporous substrate 14, depending on the exact nature of the compounds being separated. For instance, if the membrane 10 is intended to be used to purify water, the membrane 10 will allow water to pass through, but not contaminants such as salt ions.

A plurality of these membranes 10 are bonded together into a spiral-wound membrane element, using the two-component polyurethane adhesive that comprises, as the isocyanate reactive component, the isocyanate reactive and hydrogenated castor oil composition as disclosed herein.

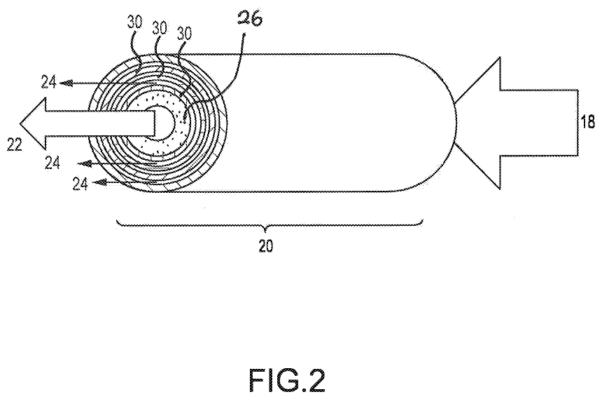

FIGS. 2-4 show together, a typical spiral-wound membrane element 20 (FIG. 2) and the various components and the construction of the spiral-wound membrane element 20.

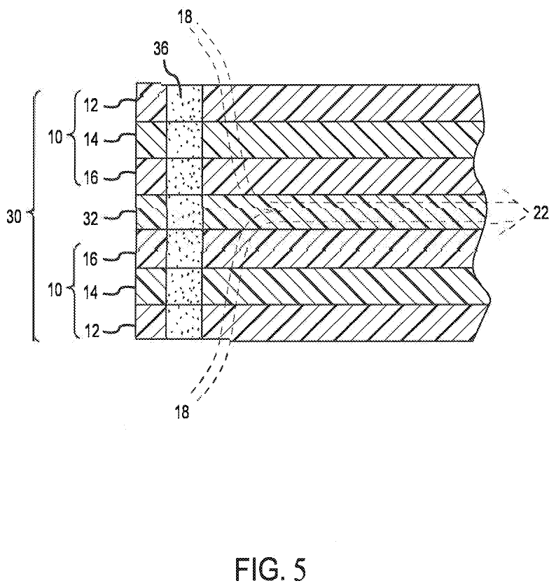

FIG. 2 shows schematically one embodiment of a spiral-wound membrane element 20 comprised of a center perforated permeate tube 26, around which is wound one or more membrane leaf elements 30 (one shown in FIG.5). During use one end of the permeate tube 26 is open to allow permeate 22 to flow out and the opposing end is sealed to prevent ingress of a feed stream 18 into the permeate tube 26. The membrane leaf elements 30 are described in more detail below. Each membrane leaf element 30 may be separated by a feed spacer 28, typically a polymeric net structure. A feed stream 18 enters the spiral-wound membrane element 20 flowing through the space between the membrane leaf element provided by the feed spacer 28. The feed stream 18 is comprised of at least two constituents. A typical illustrative example of the feed stream 18 would be salt water having an initial concentration of salt. Water with none or a lower concentration of salt goes through the membranes 10 to form a permeate stream 22 of clean water. The remainder of the feed stream 18, now having a higher concentration of salt than it started with, forms a concentrate stream 24. The permeate stream 22 is directed through a porous permeate carrier layer 32 into the permeate tube 26 and discharged therefrom. The concentrate stream 24 flows through a feed spacer 28 between the membrane leaf elements 30 and is discharged separately from the permeate stream 22.

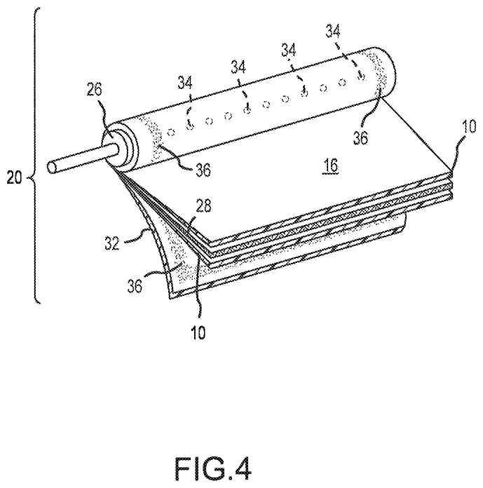

In one embodiment shown in FIG. 5 each membrane leaf element 30 is comprised of two membranes, each 10, separated by a porous permeate carrier layer 32. The membranes 10 are arranged so that each barrier layer 12 faces outwardly and each support layer 16 is adjacent to the carrier layer 32. The two-component polyurethane adhesive 36 described herein is applied to a portion of the porous permeate carrier layer 32 and/or one or both of the adjacent porous support layers 16. Adhesive 36 is applied only adjacent one or more edges of the membrane material and is not applied over the entire surface. The method of applying the two-component polyurethane adhesive 36 is not particularly limited and suitable methods are known to the skilled person. For instance, the components of two-component polyurethane adhesive 36 can be mixed just before use and applied as a continuous bead along the open edges of the porous permeate carrier 32, as seen in FIG. 4. The bead size is not particularly limited but it should bond only the edges of folded sheet 10 to the permeate carrier 32, leaving the interior portion of each unbonded. Suitable bead widths can be for instance about 0.3 cm to about 2 cm or about 0.3 cm to about 0.6 cm. The layers 10, 32, 10 are superimposed. It is desirable for the adhesive 36 to penetrate through the permeate carrier layer 32 and into or through each of the membranes 10. The adhesive seals the membrane edges 10 to prevent the feed stream from entering into the membrane 10 and carrier layer 32 and also prevent permeate 22 from exiting the membranes except through the permeate tube 26. Importantly, the adhesive 36 must penetrate 40% or more into all three layers (porous support layer 16, microporous layer 14 and the barrier layer 12 shown in FIG. 1) of the membrane 10 and permeate carrier 32 to be acceptable. Penetration of 50%, 60% , 70%, 80% or more is preferable. This bonding process, i.e. bonding the porous permeate carrier layer 32 to the center perforated permeate tube 26, and/or bonding the folded membrane sheet 10 (that has the feed carrier 28 between the folded sheet 10) to the porous permeate carrier layer 32 on three sides, to form a membrane leaf element 30 is repeated as many times as necessary until the desired number of membrane leaf elements are formed and attached to the permeate tube 26. The membrane leaf elements 30 are then wound tightly around the permeate tube 26 to form the spiral-wound element 20.

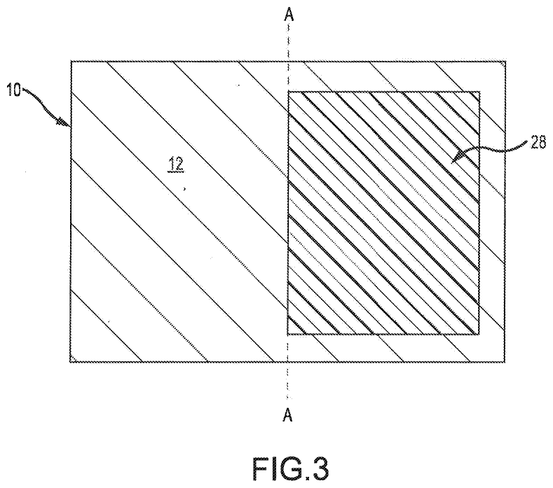

In one variation the membrane leaf element 30 layers, whether of a single wound membrane leaf element or of a plurality of membrane leaf elements, are separated by a layer of feed spacer or feed carrier 28. As shown in FIG. 3, a layer of membrane 10 is laid out such that the semi-permeable layer 12 is facing toward the inside of the sheet 10 and the support layer 16 (not visible in FIG. 3) is on the outside. A layer of feed spacer or feed carrier 28 is placed over a portion of the surface of permeable layer 12. The combined layers are folded along line A-A to form a composite structure with the feed spacer 28 disposed between two membrane layers 10. The feed spacer or feed carrier layer 28 is intended to provide space so that the feed 18 can flow freely inside the folded membrane sheet 10. The particular details of the materials and thickness of the feed carrier 28 depend on the intended application of the spiral-wound membrane element 20, but usually it is a non-woven material that allows free flow of the feed stream 18 between the adjacent folded portions of membrane sheet 10. Note that the feed carrier 28 may be slightly smaller than the folded membrane sheet 10, as shown schematically in FIG. 3.

In some applications only one membrane leaf element is wound around the permeate tube. In larger applications a plurality of membrane leaf elements can be wound around a single permeate tube. FIG. 4 shows one embodiment in which a single leaf element 30 is wound around the permeate tube 26. In this embodiment the permeate tube 26 has a plurality of perforations 34. The porous permeate carrier layer 32 of the membrane leaf element 30 is wrapped around and bonded to the center perforated permeate tube 26 with adjacent layers of the leaf element separated by a feed carrier 28. The two-component polyurethane adhesive 36 described herein can optionally be used to bond the carrier layer 32 to the permeate tube 26. The porous permeate carrier 32 provides a flow channel to allow permeate 22 to flow through membrane 10, through the permeate carrier 32 and into the permeate tube 26.

### Materials and Abbreviations Used in the Following Examples

NCO: —N═C═O isocyanate functionality, reported as weight percent of the polyisocyanate or polyisocyanate pre-polymer

Castor Oil: isocyanate reactive component of the two-component adhesive; molecular weight 923.7 Daltons, average functionality 2.7 (Vertellus)

RHEOCIN® R : micronized hydrogenated castor oil; rheology modifier (BYK)

FILMTEC™ BW30: reverse osmosis membrane (Dow)

LUPRANATE® 102: polyisocyanate; weight percent NCO about 23% and viscosity about 900 mPA·sec at 25°, average functionality about 2.05; (BASF)

ADVITROL® 100: amide modified micronized hydrogenated castor oil wax; rheology modifier (Elementis)

DISPARLON® 6500: non-reactive polyamide thixotrope; rheology modifier (King Industries)

CERAFLOUR® 970: micronized polypropylene-based wax; rheology modifier (BYK)

AEROSIL® R202: hydrophobic fumed silica; (Evonik) OMYACARB® FT: calcium carbonate: rheology modifier (Omya)

### EXAMPLES

Representative Procedures:

Polyol/rheology Modifier Composition (Isocyanate Reactive Component) Rheology Evaluation:

Viscosity at various shear rates was measured with a Rheoplus Rheometer at 25° C. using the cone and plate method. The polyol/rheology modifier composition was directly applied to the plate and the viscosity data at different shear rates were recorded.

### Mixed Two-Component Adhesive System Rheology Evaluation:

The viscosity of the mixed two-component adhesive system was measured with a Rheoplus Rheometer at 25° C. using the cone and plate method.

For all adhesive samples LUPRANATE® 102 (BASF) was used as the polyisocyanate component and mixed with the indicated polyol/rheology modifier mixture (the isocyanate reactive component).

The two components were mixed in a mixing cup for 1 minute by FlackTeck Speedmixer™ (DAC 600 FVC) in various ratios designed keep the NCO index (NCO:OH molar ratio) at about 1.15. The mixed material was then immediately applied to the plate and the viscosity data at different shear rates were recorded. The hydroxyl value of any hydrogenated castor oil and any amide modified hydrogenated castor oil rheology modifier was included in the NCO index.

### Example 1

### Preparation of a Polyol Composition with Different Rheology Modifiers

In this example, various rheology modifiers/thickeners for the isocyanate reactive component were compared. Castor oil was used as the isocyanate reactive component in all of the following Examples. The castor oil may also be referred to as “polyol” herein.

The rheology modifiers/thickeners were dispersed at various weight percents into the castor oil. These isocyanate compositions with different rheology modifiers/thickeners are listed in Table 1.

The dispersion procedure was: First, charge the castor oil and thickener or rheology modifier to the mixer. Then, mix at medium shear while maintaining the temperature between 40° C. and 80° C. under vacuum for 1 hour or more until the rheology modifier or thickener is completely dispersed. The heat was turned off and the mixture was allowed cool to room temperature (approximately 25° C.) without mixing. The polyol composition was discharged into a metal can which was filled with nitrogen and stored at room temperature for further evaluation.

TABLE 1
Isocyanate reactive component (polyol) compositions with various rheology modifiers

| Poyol (weight %) | | | Rheology modifiers (weight %) | | | | |
|---|---|---|---|---|---|---|---|
| | | RHEOCIN ® | ADVITROL ® | DISPARLON ® | CERAFLOUR ® | AEROSIL ® | OMYACARB ® |
| | Castor | R | 100 | 6500 | 970 | R202 | FT |
| Sample | oil | inventive | inventive | comparative | comparative | comparative | comparative |
| A0 | 100 | 0 | 0 | 0 | 0 | 0 | 0 |
| A1 | 90 | 10 | 0 | 0 | 0 | 0 | 0 |
| A6 | 92.5 | 7.5 | 0 | 0 | 0 | 0 | 0 |
| A11 | 95 | 5 | 0 | 0 | 0 | 0 | 0 |
| B1 | 90 | 0 | 10 | 0 | 0 | 0 | 0 |
| B2 | 92.5 | 0 | 7.5 | 0 | 0 | 0 | 0 |
| B3 | 95 | 0 | 5 | 0 | 0 | 0 | 0 |
| A2 | 90 | 0 | 0 | 10 | 0 | 0 | 0 |
| A7 | 92.5 | 0 | 0 | 7.5 | 0 | 0 | 0 |
| A12 | 95 | 0 | 0 | 5 | 0 | 0 | 0 |
| A3 | 91.9 | 0 | 0 | 0 | 0 | 8.1 | 0 |
| A8 | 93.9 | 0 | 0 | 0 | 0 | 6.1 | 0 |
| A13 | 95.9 | 0 | 0 | 0 | 0 | 4.1 | 0 |
| A4 | 60 | 0 | 0 | 0 | 0 | 0 | 40 |
| A9 | 70 | 0 | 0 | 0 | 0 | 0 | 30 |
| A14 | 80 | 0 | 0 | 0 | 0 | 0 | 20 |
| A5 | 72.5 | 0 | 0 | 0 | 27.5 | 0 | 0 |
| A10 | 79.4 | 0 | 0 | 0 | 20.6 | 0 | 0 |
| A15 | 86.2 | 0 | 0 | 0 | 13.8 | 0 | 0 |

### Example 2

### Evaluation of Polyol/Rheology Modifier Composition Rheology

Rheology of the polyol/rheology modifier compositions in Table 1 are shown in Table 2. The thixo ratios shown in the last two columns are the viscosity at 1 sec⁻¹ divided by the viscosity at 10 sec⁻¹ and the viscosity at 2 sec⁻¹ divided by the viscosity at 20 sec⁻¹. These ratios (1/10 and 2/20 in Table 2) are considered an indication of the shear-thinning of the fluid. The viscosity was measured according to the procedure above.

TABLE 2
Rheology properties of castor oil with
various rheology modifiers

| polyol | Viscosity (mPa · sec) | | | | Thixo ratios | |
|---|---|---|---|---|---|---|
| sample | 1 sec⁻¹ | 2 sec⁻¹ | 10 sec⁻¹ | 20 sec⁻¹ | 1/10 | 2/20 |
| A0 (control) | 810 | 774 | 787 | 775 | 1.05 | 1.01 |
| IA1 | 3,883,000 | 1,405,000 | 37,170 | 20,140 | 104.47 | 69.76 |
| invention | | | | | | |
| IA6 | 803,000 | 197,100 | 12,450 | 7519 | 64.5 | 26.21 |
| invention | | | | | | |
| IA11 | 56,660 | 15,240 | 4519 | 3266 | 12.54 | 4.67 |
| invention | | | | | | |
| IB1 | 287,600 | 141,800 | 20,640 | 9691 | 13.93 | 14.63 |
| invention | | | | | | |
| IB2 | 67,170 | 36,250 | 8175 | 4846 | 8.22 | 7.48 |
| invention | | | | | | |
| IB3 | 29,560 | 16,140 | 4362 | 2778 | 6.78 | 5.81 |
| invention | | | | | | |
| CA2 | 160,500 | 86,300 | 16,360 | 8301 | 9.81 | 10.4 |
| comparative | | | | | | |
| CA7 | 26,370 | 15,400 | 5364 | 3686 | 4.92 | 4.18 |
| comparative | | | | | | |
| CA12 | 10,800 | 7050 | 3048 | 2303 | 3.54 | 3.06 |
| comparative | | | | | | |
| CA5 | 4921 | 4461 | 3820 | 3712 | 1.29 | 1.20 |
| comparative | | | | | | |
| CA10 | 2332 | 2142 | 1909 | 1877 | 1.22 | 1.14 |
| comparative | | | | | | |
| CA15 | 1483 | 1449 | 1369 | 1360 | 1.08 | 1.07 |
| comparative | | | | | | |
| CA3 | 220,800 | 120,000 | 33,430 | 20,550 | 6.60 | 5.84 |
| comparative | | | | | | |
| CA8 | 60,680 | 34,980 | 10,680 | 7082 | 5.68 | 4.94 |
| comparative | | | | | | |
| CA13 | 22,740 | 13,550 | 4896 | 3448 | 4.64 | 3.93 |
| comparative | | | | | | |
| CA4 | 10,500 | 6839 | 3372 | 2746 | 3.11 | 2.49 |
| comparative | | | | | | |
| CA9 | 4549 | 3361 | 1962 | 1694 | 2.32 | 1.98 |
| comparative | | | | | | |
| CA14 | 2017 | 1806 | 1295 | 1191 | 1.56 | 1.52 |
| comparative | | | | | | |

Viscosity data for the castor oil and castor oil mixed with various rheology modifiers at shear rates of 1 sec⁻¹, 2 sec⁻¹, 10 sec⁻¹, and 20 sec⁻¹ are shown in Table 2.

Polyol viscosity at different shear rate and thixo ratio demonstrates the thickening (i.e., increase in viscosity) and the thixotropic effect of those organic and inorganic rheology modifiers. Among the organic rheology modifiers, hydrogenated castor oil RHEOCIN® R is the most efficient one at building up a high viscosity and a high thixo ratio. Castor oil derivative ADVITROL® 100 also increased the viscosity and shear thinning of the castor oil. Polyamide DISPERSON® 6500 is not as effective as either of the hydrogenated castor oil rheology modifiers. In this castor oil system, polypropylene powder the CERAFLOUR® 970 does not increase the viscosity well even with 40% of filler loading. The inorganic additive, calcium carbonate behaves similarly to polypropylene powder and did not increase the viscosity of the castor oil effectively. Silane modified (hydrophilic) fumed silica AEROSIL® R202 was able to increase viscosity as effectively as the hydrogenated castor oil, but had much lower thixo ratios than either the hydrogenated castor oil and the amide modified hydrogenated castor oil.

### Example 3

### Evaluation of Rheology of Two-Component Adhesive Immediately After Mixing the Two Components

The castor oil/rheology modifier compositions shown in Table 1 that were demonstrated to have adequate viscosity increasing ability were mixed with LUPRANATE® 102 as the polyisocyanate component. The rheology was evaluated according to the above procedure and is shown in Table 3.

TABLE 3
Rheology properties of just-mixed two-component
adhesives with various rheology modifiers

| polyol | Viscosity (mPa · sec) | | | | Thixo ratios | |
|---|---|---|---|---|---|---|
| sample | 1 sec⁻¹ | 2 sec⁻¹ | 10 sec⁻¹ | 20 sec⁻¹ | 1/10 | 2/20 |
| IA1 | 124,700 | 53,330 | 13,410 | 9757 | 9.30 | 5.47 |
| invention | | | | | | |
| IA6 | 28,960 | 15,390 | 5780 | 4491 | 5.01 | 3.43 |
| invention | | | | | | |
| IA11 | 10,720 | 6455 | 3073 | 2655 | 3.49 | 2.43 |
| invention | | | | | | |
| IB1 | 37,240 | 22,010 | 7004 | 4948 | 5.32 | 4.45 |
| invention | | | | | | |
| IB2 | 15,490 | 9867 | 4217 | 2242 | 3.67 | 4.40 |
| invention | | | | | | |
| IB3 | 6273 | 4563 | 2464 | 2242 | 2.55 | 2.04 |
| invention | | | | | | |
| CA2 | 57,190 | 32,890 | 9668 | 6339 | 5.92 | 5.19 |
| comparative | | | | | | |
| CA7 | 29,350 | 17,090 | 6413 | 4442 | 4.58 | 3.85 |
| comparative | | | | | | |
| CA12 | 14,240 | 9197 | 3742 | 2867 | 3.81 | 3.21 |
| comparative | | | | | | |
| CA3 | 64,480 | 36,200 | 11,870 | 8444 | 5.43 | 4.29 |
| comparative | | | | | | |
| CA8 | 31,360 | 18,410 | 6822 | 5169 | 4.60 | 3.56 |
| comparative | | | | | | |
| CA13 | 18,730 | 13,190 | 7289 | 6597 | 2.57 | 2.00 |
| comparative | | | | | | |

Notably, the thixo ratio of the mixed two-component adhesives were reduced after the isocyanate reactive polyol (i.e., castor oil) comprising the rheology modifiers was mixed with the isocyanate component. The just-mixed two-component adhesive comprising hydrogenated castor oil had a higher thixo ratio than other compositions. The just-mixed two-component adhesive comprising amide modified hydrogenated castor oil had a similar thixo ratio as those comprising the polypropylene wax and the silane-modified fumed silica.

### Example 4

### Membrane Penetration

To measure the membrane penetration, polyol compositions as shown in Table 1 were mixed with polyisocyanate LUPRANATE® 102 (BASF).

The two components were mixed in a mixing cup for 1 minute with a FlackTeck Speedmixer™ (DAC 600 FVC) in various ratios as necessary to keep the NCO index (NCO:OH molar ratio) of the two-component adhesive at 1.15. Importantly, the hydroxyl value of the hydrogenated castor oil and the amide modified hydrogenated castor oil rheology modifier was included in the NCO index.

Squares of membrane (approximately 7.5 cm×7.5 cm) were placed on a surface of the porous support layer 16. Approximately 5 grams of the mixed adhesive was placed on that membrane. The porous support layer 16 of a second membrane was placed on top of the mixed adhesive. A non-stick plastic square (polyethylene, dimensions approximately 12 cm×12 cm) was placed on top of the assembled membranes. An approximately 450 gram weight was then placed over the top of the entire non-stick plastic square. The weight was left for 20 minutes and then removed. The assembly was allowed to cure for at least 8 hours and the percent penetration was evaluated visually and reported as membrane penetration. Unless otherwise noted FILMTEC™ BW30 membranes were used for penetration testing.

Penetration was qualitatively estimated by visual analysis of the ratio of dark area to light area on the back side (i.e. on the barrier layer side 12 opposite the support layer 16). No visual change would be 100% light area and would correspond to 0% penetration. Complete penetration would be 100% dark area and would correspond to 100% penetration. The samples were evaluated side-by-side by more than one person to ensure consistency.

TABLE 4
Membrane penetration of mixed two-component adhesive
comprising various rheology modifiers

| | Membrane Penetration | Initial viscosity of |
|---|---|---|
| | (percent of total bead area | mixed adhesive |
| | appearing darker on barrier | at 1 sec⁻¹ |
| Sample | layer side of membrane) | (mPA · sec) |
| IA1 | 90 | 124,700 |
| invention | | |
| IA6 | 80 | 28,960 |
| invention | | |
| IA11 | 85 | 10,720 |
| invention | | |
| IB1 | 80 | 37,240 |
| invention | | |
| IB2 | 80 | 15,490 |
| invention | | |
| IB3 | 85 | 6273 |
| invention | | |
| CA2 | 30 | 57,190 |
| comparative | | |
| CA7 | 25 | 29,350 |
| comparative | | |
| CA12 | 40 | 14,240 |
| comparative | | |

Membrane penetration with the adhesive compositions comprising hydrogenated castor oil (RHEOCIN® R) and amide-modified hydrogenated castor oil (ADVITROL® 100) was greater than 80%. The composition comprising polyamide (DISPERSON® 6500) had less than 40% membrane penetration which is not desirable.

Surprisingly, the inventive compositions (i.e., those comprising hydrogenated castor oil or a derivative thereof) having the highest initial viscosity had the best membrane penetration. A person skilled in the art would expect that compositions having a lower initial viscosity would more effectively flow through the layers of the membrane to achieve good wetting.

In some embodiments, the invention herein can be construed as excluding any element or process step that does not materially affect the basic and novel characteristics of the composition or process. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

What is claimed is:

1. A separation apparatus including:
a membrane layer capable of separating a first constituent from a feed fluid mixture comprising the first constituent and a second constituent;
a porous carrier layer; and
a mixed two component polyurethane adhesive disposed in one or more discrete areas between the membrane layer and the porous carrier layer to form a bonded area, wherein the two component polyurethane adhesive comprises:
A) a component A comprising a polyisocyanate wherein the polyisocyanate has an average isocyanate functionality of at least 2 and comprises between 10 and 26 weight percent of isocyanate functionality; and
B) a component B comprising an isocyanate reactive component having isocyanate reactive functional groups and a hydrogenated castor oil wax or derivative thereof, wherein the component B is capable of reacting with the polyisocyanate, has a viscosity of at least 100,000 mPa·sec at 1 sec⁻¹ and 25° C., and an initial ratio of viscosity at 1 sec⁻¹ to viscosity at 10 sec⁻¹ of at least 5;
wherein the mixed, two component polyurethane adhesive has percent penetration into the membrane layer prior to curing.

2. The separation apparatus according to claim 1, wherein the percent penetration of the membrane layer by the polyurethane adhesive is in the range of at least 40% to at least 80%.

3. The separation apparatus according to claim 1, wherein the separation apparatus further comprises a feed carrier material.

4. The separation apparatus according to claim 1, wherein the separation apparatus further comprises a porous permeate carrier layer which is bonded to the porous layer with the two component polyurethane adhesive.

5. The separation apparatus according to claim 1, wherein the component B comprises from 3 wt. % to 12 wt. % of the hydrogenated castor oil wax or derivative thereof.

6. The separation apparatus according to claim 1, wherein the component B comprises from 5 wt. % to 8 wt. % of the hydrogenated castor oil wax or derivative thereof.

7. The separation apparatus according to claim 1, wherein the component A comprises between 12 and 24 wt. % NCO functionality.

8. The separation apparatus according to claim 1, wherein the ratio of viscosity at 1 sec⁻¹ to viscosity at 10 sec⁻¹ of ii) is at least 6.

9. The separation apparatus according to claim 1, wherein the viscosity of component B at 1 sec⁻¹ and 25° C. is between 100,000 and 5,000,000 mPa·sec.

10. The separation apparatus according to claim 1, wherein the viscosity of component B at 1 sec⁻¹¹ and 25° C. is between 300,000 and 800,000 mPa·sec.

11. The separation apparatus according to claim 1, wherein the component A and the component B are each present in an amount whereby the molar ratio of isocyanate groups in component A to isocyanate reactive groups in component B is at least 1:1.

12. The separation apparatus according to claim 1, wherein the isocyanate reactive component is selected from the group consisting of polyols, polyamines, polythiols, aminoalcohols, and mixtures thereof.

13. The separation apparatus according to claim 1, wherein the isocyanate reactive component is a polyol or a mixture of polyols.

14. The separation apparatus according to claim 1, wherein the isocyanate reactive component comprises castor oil.

15. The separation apparatus according to claim 1, wherein the polyisocyanate comprises methylene diphenyl diisocyanate.

16. The separation apparatus according to claim 1, wherein the polyisocyanate comprises a pre-polymer reaction product of methylene diphenyl diisocyanate and a second polyol.

17. The separation apparatus according to claim 1, wherein the membrane layer comprises a barrier layer disposed adjacent one surface of a microporous substrate and a support layer disposed adjacent an opposing surface of the microporous substrate.

18. The separation apparatus according to claim 1, including a membrane leaf element having two opposing edges, the membrane leaf element comprising the membrane layer disposed adjacent a surface of the porous carrier layer and a second membrane layer disposed adjacent an opposing surface of the porous carrier layer, the mixed two component polyurethane adhesive disposed adjacent the edges and penetrating into the membrane leaf element at least 40%, wherein cured reaction products of the mixed two component polyurethane adhesive form a barrier along the membrane leaf edges to the fluid feed mixture, the first constituent and the second constituent and the porous carrier layer provides a flow channel within the membrane leaf element for the first constituent permeating either membrane layer.

19. A process for bonding a separation membrane to a porous backing using a polyurethane adhesive comprising the steps of:
providing a component A comprising a polyisocyanate wherein the polyisocyanate has an average NCO functionality of at least 2;
providing a component B comprising an isocyanate reactive component having isocyanate reactive functional groups and a hydrogenated castor oil wax or derivative thereof, wherein the component B can react with the polyisocyanate and wherein the component B has a viscosity of at least 100,000 mPa·sec at 1 sec⁻¹ and 25° C. and a ratio of viscosity at 1 sec⁻¹ to viscosity at 10 sec⁻¹ of at least 5;
mixing component A with component B to form the polyurethane adhesive;
applying the polyurethane adhesive to at least one of the separation membrane and the porous carrier layer to form a bonded area; and
allowing the polyurethane adhesive to cure;
whereby a percent penetration of the membrane by the mixed polyurethane adhesive as measured by percent of dark area relative to the total area of the bonded area is at least 40%.
